(19) United States
(12) Patent Application Publication
(10) Pub. No.: US 2008/0034625 A1
(43) Pub. Date: Feb. 14, 2008

(54) PLATEGUARD

(75) Inventor: Jesus Pacleb, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: Jesus Pacleb, San Diego, CA (US)

(21) Appl. No.: 11/835,181

(22) Filed: Aug. 7, 2007

Related U.S. Application Data
(60) Provisional application No. 60/822,189, filed on Aug. 11, 2006.

(51) Int. Cl. G09F 7/00; B60R 13/10

(52) U.S. Cl. 40/209

(57) ABSTRACT

A license plate holder for automobiles which allows the maximum viewable area for the plate. This invention avoids the problem of the license plate frame or tabs covering portions of the plate. The plate is held firmly in the cover and the cover attaches to the automobile at the back side.

### FIELD OF THE INVENTION

The present invention relates, in general, to a license plate holder and method for using the same. More particularly, the present invention relates to a license plate holder for automobiles which allows the maximum viewable area for the plate. This invention avoids the problem of the license plate frame or tabs covering portions of the plate. The plate is held firmly in the cover and the cover attaches to the automobile at the back end.

### BACKGROUND OF THE INVENTION

There are many license plate cover designs used to hold license plates to cars. The license plate holders currently in existence require a thicker outer frame or clamps on the front of the license plate which block a portion of the face of the license plate. The current plate holders usually only are manufactured with a frontal piece and no back portion. The current license plate holders which give the best view of the plate still have components which block the plate view and are often those which cannot be very securely fastened to the car or are flimsy in nature.

There is, thus, a need for a license plate holder which allows a full view of the license plate front and can be securely fastened to the automobile.

### SUMMARY OF THE INVENTION

Accordingly, an aspect of the invention involves a method for use and manufacture of a license plate holder which provides the maximum viewable area for plate with the ability to be securely attached to an automobile. The method includes providing a plate holder manufactured of various materials wherein the license plate can be slid into the holder and securely fastened to the car but allows a maximized viewable area of the license plate. In one embodiment the plate is slid through the top of the plateguard, while in another embodiment the plate is slid in through the side of the plateguard. The plateguard is securely fastened to the automobile via four screws which thread through the front of the license plate and the back side of the plateguard. This plateguard can be manufactured in various embodiments which will be referred to as embodiments in the remainder of this specification. The frontal face of the plateguard can be manufactured in multiple different three dimensional finishes which is displayed in the figures and described in more detail below.

### BRIEF DESCRIPTION OF THE DRAWINGS

The accompanying drawings, which are incorporated in and constitute a part of the specification, illustrate embodiments of the invention and, together with the description, serve to explain the objects, advantages, and principles of the invention. In the drawings,

FIG. 1A is a perspective rear view of an embodiment number 1 of the plateguard;

FIG. 1B is a side cross section view of embodiment number 1 of the plateguard;

FIG. 1C is a perspective frontal view of embodiment number 1 of the plateguard;

FIG. 2A is a perspective rear view of an embodiment number 2 of the plateguard;

FIG. 2B is a side cross section view of embodiment number 2 of the plateguard;

FIG. 2C is a perspective frontal view of embodiment number 2 of the plateguard;

FIG. 3A is a perspective rear view of an embodiment number 3 of the plateguard;

FIG. 3B is a side cross section view of embodiment number 3 of the plateguard;

FIG. 3C is a perspective frontal view of embodiment number 3 of the plateguard;

FIG. 4A is a perspective rear view of an embodiment number 4 of the plateguard;

FIG. 4B is a side cross section view of embodiment number 4 of the plateguard;

FIG. 4C is a perspective frontal view of embodiment number 4 of the plateguard;

FIG. 5A is a perspective rear view of an embodiment number 5 of the plateguard;

FIG. 5B is a side cross section view of embodiment number 4 of the plateguard;

FIG. 5C is a perspective frontal view of embodiment number 5 of the plateguard;

FIG. 6A is a perspective rear view of an embodiment number 6 of the plateguard;

FIG. 6B is a side cross section view of embodiment number 6 of the plateguard;

FIG. 6C is a perspective frontal view of embodiment number 6 of the plateguard;

FIG. 7 is a perspective rear view of an embodiment number 7 of the plateguard;

FIG. 8 is a perspective rear view of an embodiment number 8 of the plateguard;

FIG. 9 is a perspective rear view of an embodiment number 9 of the plateguard;

FIG. 10 is a perspective rear view of an embodiment number 10 of the plateguard;

FIG. 11 is a perspective rear view of an embodiment number 11 of the plateguard;

FIG. 12 is a perspective rear view of an embodiment number 12 of the plateguard;

FIG. 13 is a cross-sectional side view of the top frame of one embodiment of the plateguard;

FIG. 14 is a cross-sectional side view of the frame of an embodiment of the plateguard;

FIG. 15 is a cross-sectional view of the top frame of an embodiment of the plateguard;

FIG. 16 is a cross-sectional side view of the top frame of an embodiment of the plateguard;

FIG. 17 is a cross-sectional side view of the top frame of an embodiment of the plateguard.

### DETAILED DESCRIPTION OF PREFERRED EMBODIMENTS

After reading this description it will become apparent to one skilled in the art how to implement the invention in various alternative embodiments and alternative applications. However, all the various embodiments of the present invention will not be described herein. It is understood that the embodiments presented here are presented by way of an example only, and not limitation. As such, this detailed description of various alternative embodiments should not be construed to limit the scope or breadth of the present invention as set forth below.

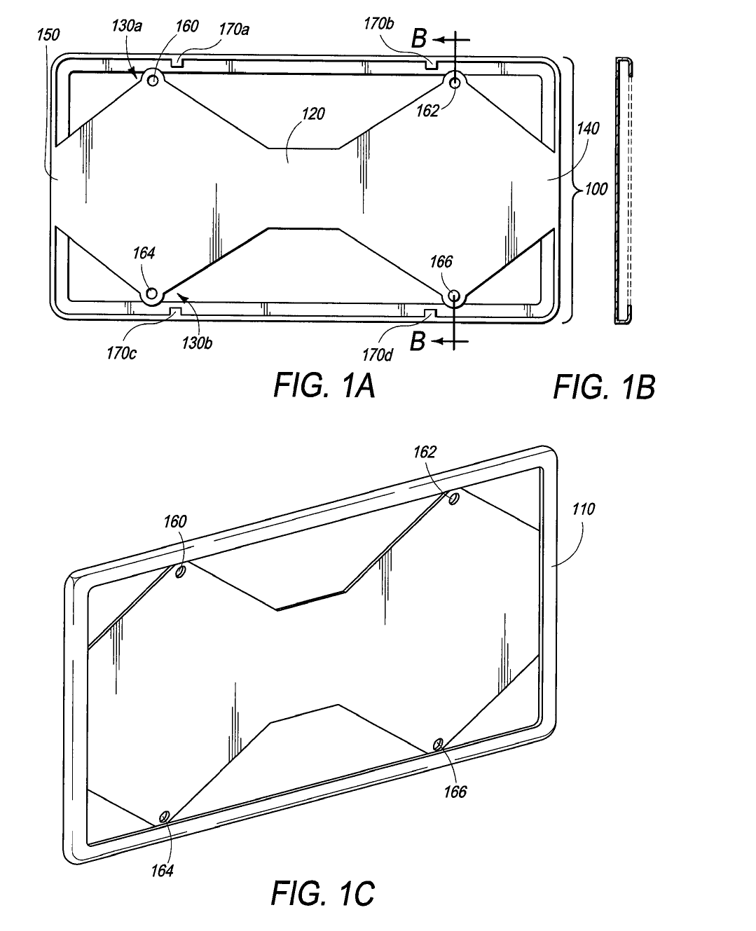

With a reference to FIGS. 1A, 1B and 1C, a preferred embodiment of the license plate holder the plateguard 100 is shown and displayed. A plateguard 100 is a sturdy unit which holds a license plate securely to the front or back of an automobile or truck. The plateguard 100 is unique in that it has not front tabs or extensions which cover any portion of the front side of the license plate. The plateguard 100 is very unobtrusive in that it only covers a small surface area of the license plate. The front face 110 of the plateguard only covers ¼ to ½ inch of the circumference of the license plate. License plates in all 50 states have an edge which is either beveled or channeled, the plateguard 100 covers this portion. In a preferred embodiment the plateguard 100 can be manufactured so that the back portion and the front portion are all one unit. This plateguard 100 allows the license plate to be slid into the frame through the top or bottom or in alternate embodiments the right and left. The back of the plateguard 100 can be bent at the top or bottom side to allow the license plate to be slid into place and the frame will retract back into shape. In FIG. 1A the back 120 has a double diamond shape. In this embodiment, the back side 120 of the plateguard 100 is attached to the front side of the plateguard at the right 140 and left 150 sides. The length of the connection piece of the front and back approximately ranges from 1/12 to ½ the entire length of the side of the plateguard. This configuration allows the top or bottom of the back side 120 to be easily flexed for insertion of the license plate. The angles of the top or bottom portion of the back side can be modified depending on the material used to manufacture the plateguard 100.

The license plate is further held in place in the plateguard 100 by the small tabs 170(a), (b), (c) and (d) on the right and left and top and bottom sides. The small tabs can be placed at various distances from one another depending on the particular embodiment of the plateguard 100. When the plateguard 100 is manufactured from metal, the tabs can be bent in when the user pushes on them. In embodiments which are manufactured from a plastic type substance the tabs are formed in a triangle configuration. This triangle configuration allows the plate to be easily slid into the plateguard 100 but inhibits the license plate from being removed from the plateguard 100.

The plateguard 100 is secured to the car by four bolts which are screwed through holes 260, 262, 264 and 266 in the plateguard and into the license plate. The back side 120 of the plateguard is mounted directly onto the automobile's license plate space. This plateguard 120 is rigid and sturdy due to its large portion of surface area on the rear side. The plateguard is also pliable and retracts back into shape if it is bent. This embodiment of the plateguard 120, as well as the remaining embodiments of the plateguard which will be described in more detail below can be manufactured from various substances. A few of the substances which may be used would include Eastman Durastar™ polymer, high impact polymer, ABS natural plateable grade plastic, ABS plastic, high impact polystyrene (HIPS or PS-I), styrene polymers, styrene, high resistant nylon, heat resistant nylon, sheet metal, aluminum, stainless steel, carbon fiber, flexible graphite, polyurethane, wood, flexible fiberglass, ethylene propylene diene monomer (E.P.D.M.), brass, and dye cast zinc and/or a variety of other substances.

The embodiments displayed in FIGS. 1, 2, 3, 4, 5, 6, 7, 8, 9, 10, 11 and 12 of the license plate are sturdier and stronger than the standard license plate holders because of its insert design nature and larger rear surface area securing the top and bottom of the frame. Due to its slim design the plateguard 100 allows any license plate to slide into the plateguard 100 and does not allow a license plate to get obstructed or stuck due to the fact that it has stickers, slogans or other commemorative statements which cause the license plate to be thicker in diameter. The plateguard 100 disclosed herein meets the legal dimension requirement in all fifty of the United States because it only covers a little over ¼ of an inch of the entire circumference of the license plate face. The configuration of the front face 110 of the plateguard 100 allows the maximum surface area of the license plate to remain unobstructed.

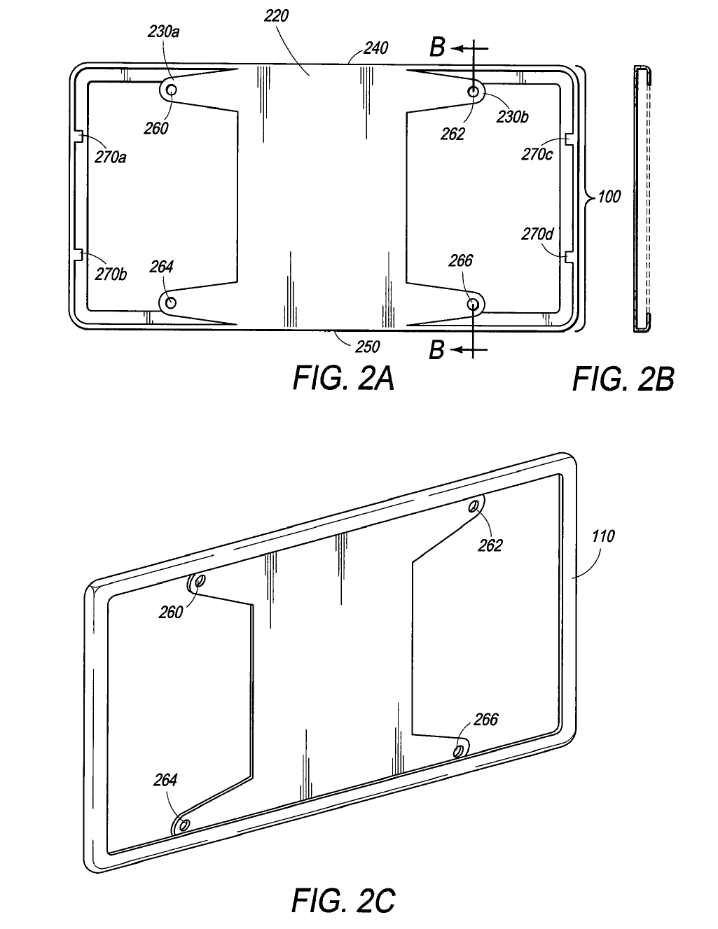

The second preferred embodiment of the plateguard 100 is displayed in FIGS. 2A, 2B and 2C. In the second embodiment the license plate is inserted into the plateguard via the left 230a or right side 230b. The backside 220 of the plateguard is attached to the front side of the plateguard at the top 240 and bottom 250 sides. The length of the connection piece of the front and back ranges from 1/12 to ½ the entire length of the top or bottom length of the plateguard. This configuration allows the right or left of the back top and bottom to be easily flexed for insertion of the license plate. The angles of the right or left portion of the backside can be modified depending on the material used to manufacture the plateguard.

The license plate is further held in place by the small tabs 270(a), (b), (c) and (d) on the right and left side. When the plateguard is manufactured from metal, the tabs can be bent in when the user pushes on them. In embodiments which are manufactured from a plastic type substance the tabs are formed in a triangle configuration. This triangle configuration allows the plate to be easily slid into the plateguard 100 but inhibits the license plate from being removed from the plateguard 100. The plateguard 100 is then secured to the automobile via four screws which feed through the holes 260, 262, 264 and 266 in the license plate and through the back of the plateguard 100. This plateguard 100 is sturdy and rigid as a result of the material which extends from the top to the bottom of the plateguard forming a thick “I” shape. The plateguard 100 also has the added feature of not being too heavy which would result if the entire back of the plateguard 100 was a solid substance.

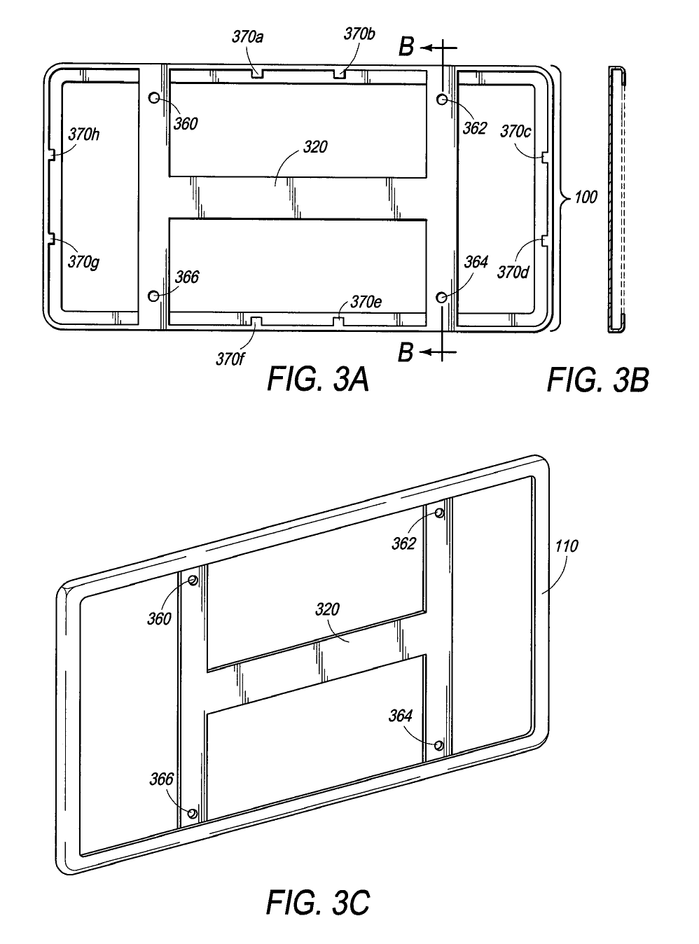

Another embodiment of the plateguard 100 is displayed as embodiment 3 in FIGS. 3A, 3B and 3C. Embodiment 3 of the plateguard allows the license plate to be inserted from the left or right side. The license plate is then secured by the side tabs 370(a), (b), (c), (d), (e), (f), (g) and (h) which appear on both lateral sides and the top and bottom inside back of the plateguard. The back 320 of the plateguard is manufactured in a sturdy configuration wherein the material from which the plateguard is manufactured is formed in an H-shape wherein the two sides of the H attach to the top and the bottom of the plateguard 100 and the center piece of the H connects the two longitudinal connector pieces. This configuration allows the plateguard to be rigid and not flimsy. The plateguard 100 is then secured to the automobile via screws which feed through the license plate and then the four holes on the four arms of the H are 360, 362, 364 and 366.

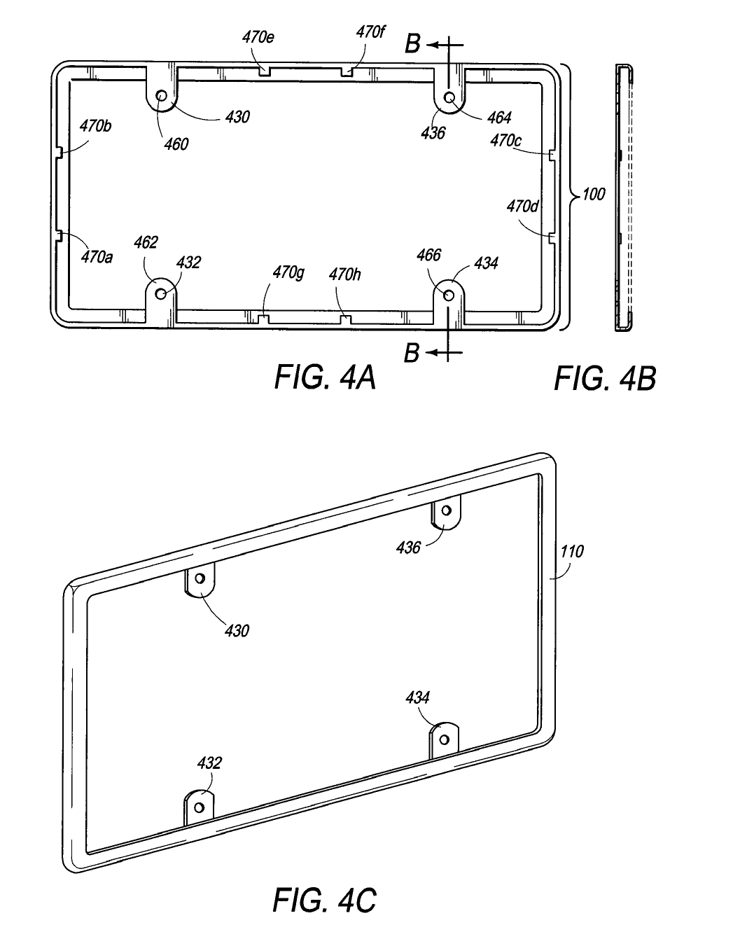

Another embodiment of the plateguard 100 is displayed in FIGS. 4A, 4B and 4C. This embodiment 4 of the plateguard 100 uses four small rounded extensions 430, 432, 434 and 436 which extend into the interior space of the back side of the plateguard and each contain a small hole 460, 462, 464 and 466. A screw threads through the small hole in each of the extensions to secure the plateguard to the car. The license plate can be slid into the side of embodiment 4. In embodiment 4, once the license and plate is slid into the plateguard it is held firmly in place by the tabs 470(a), (b), (c), (d), (e), (f), (g) and (h) which are located on the back side of the plateguard. This embodiment 4 of the plateguard allows a large portion of the plate to be seen on the front side. One half an inch or less of an inch of the circumference of the license plate is covered once it is inserted into this plateguard.

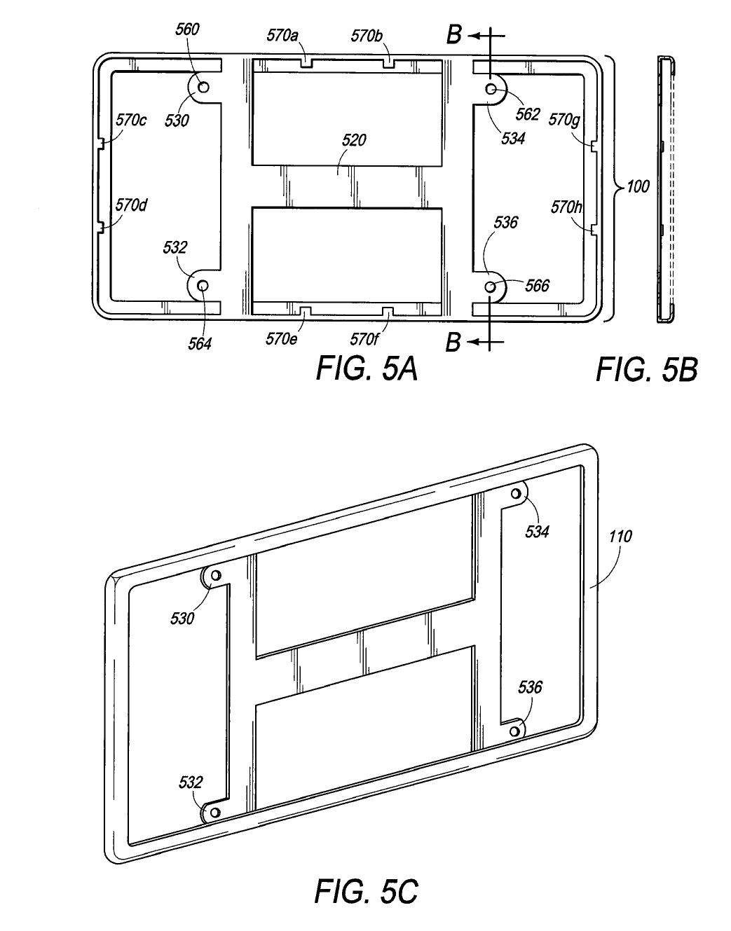

Another embodiment of the plateguard is displayed in FIGS. 5A, 5B and 5C. The embodiment displayed in these figures is referred to as embodiment 5. This embodiment is very similar to the embodiment set forth in FIGS. 3A, 3B and 3C. The only differences between embodiment 3 and embodiment 5 is that in embodiment 5 the H frame has four small extensions 530, 532, 534 and 536 which extend on the top and bottom lateral sides of the arms of the H. The extensions 530, 532, 534 and 536 extending from the H contain small holes 560, 562, 564, and 566. Screws are threaded through the license plate and the small holes 560, 562, 564 and 566 in the plateguard which is secured to the automobile. In this embodiment 5 of the plateguard the license plate is slid into the sides and is secured by the small square tabs 570 (a), (b), (c), (d), (e), (f), (h), and (g) located on the top, bottom and sides. Embodiment 3 and embodiment 5 can be each manufactured with the various substances set forth above. Some of the materials are better suited to work with the manufacture of embodiment 3 while other substances are better suited to work in the manufacture of embodiment 5.

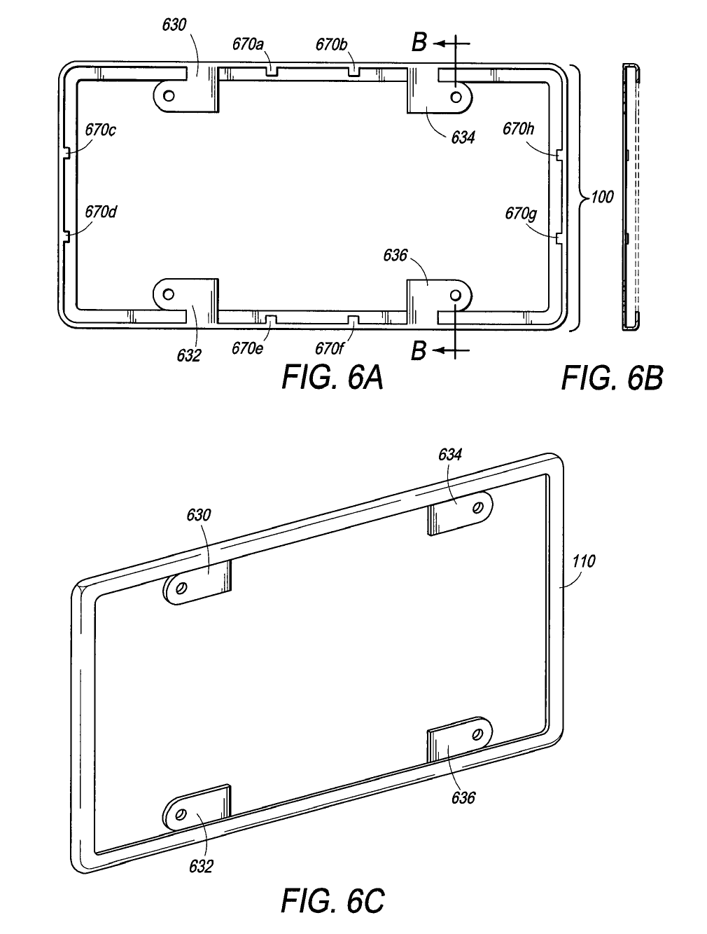

A further embodiment is displayed in FIGS. 6A, 6B and 6C. This embodiment is very similar to the embodiment displayed in FIGS. 4A, 4B and 4C. The difference in this embodiment is that the round extensions 630, 632, 634 and 636 which secure the plateguard to the automobile are shaped to look like a P, wherein the hole in the P is where the screw feeds through the back of the plateguard to secure it to the automobile. This embodiment also has square bendable tabs to 670 (a), (b), (c), (d), (e), (f), (g), and (h) the same as those disclosed in embodiment 1 and 2 above. These square tabs assist in holding the license plate firmly in the plateguard 100 when they are bent inward. The license plate is inserted into this plateguard and secures the same way as was done in embodiment 4. Again, certain manufacture materials are better suited to make embodiment 6 versus embodiment 4.

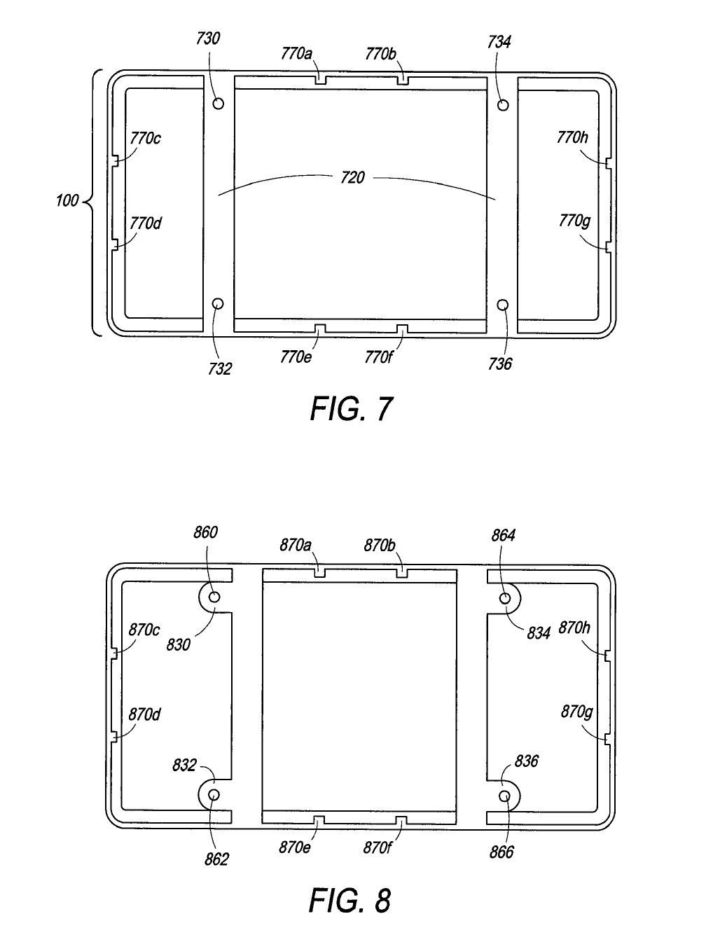

Some further embodiments of the plateguard are displayed in FIGS. 7, 8, 9, 10, 11, and 12. In FIG. 7 the back 720 of the plateguard is manufactured so that two pieces of material extend from the top of the plateguard to the bottom of the plateguard. These two pieces 720 are vertical to one another and are one to two inches in width. Each piece has two holes 730 and 732 or 734 and 736, one at the top and one at the bottom. The screws feed through the license plate and then these holes 730, 732, 734 and 736 to secure the plateguard to the automobile. FIG. 8 displays an embodiment of the plateguard similar to FIG. 7 but having small rounded extensions 830, 832, 834 and 836 extending laterally on the top and bottom sides of the horizontal pieces of material which attach to the top and the bottom of the back side of the plateguard. In embodiment 8, the holes 860, 862, 864 and 866 through which the screws feed are set in the side extensions for the horizontal pieces. In embodiment 8, four screws attach the plateguard to the automobile. Both embodiment 7 and 8 each have square tabs to hold the license plate firmly in place as can be seen by looking at FIG. 7 (770 (a), (b), (c), (d), (e), (f), (h), and (g) and FIG. 8 (870 (a), (b), (c), (d), (e), (f), (h), and (g)).

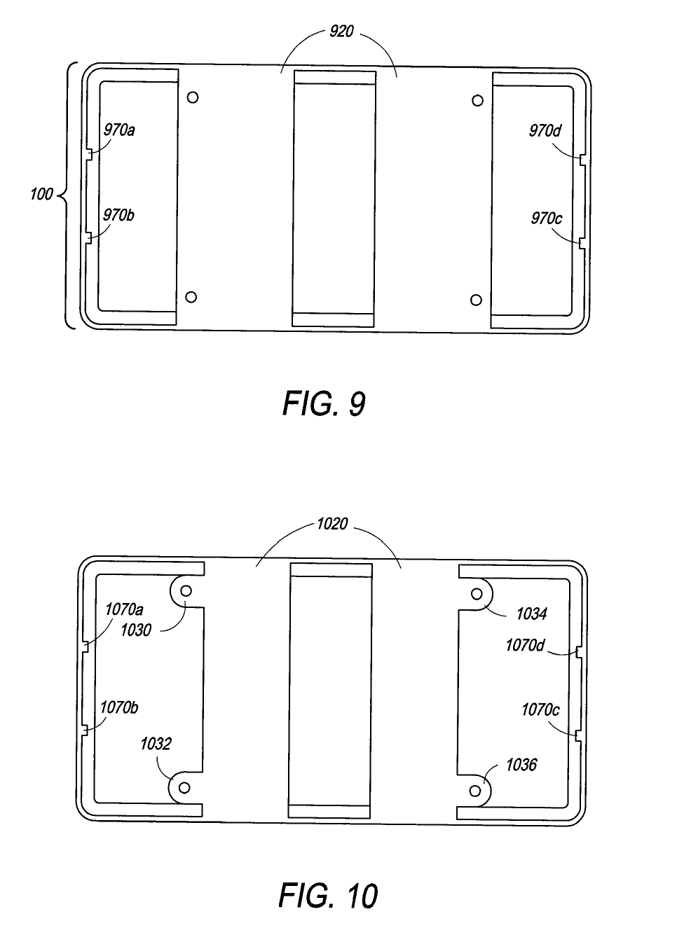

FIG. 9 displays a plateguard which is manufactured very similar to embodiment 7. Embodiment 9 differs from embodiment 7 in that the back 920 is composed of horizontal strips of material which attach to the top and the bottom of the plateguard. These strips are thicker in width than those in embodiment 7 and range from two inches to four inches. FIG. 10 displays a embodiment of the plateguard which is similar to embodiment 8 but the back 1020 is comprised of horizontal strips of material which hold the plateguard steady. The back 1020 secures the top and the bottom of the plateguard with the strips which range from two to four inches in width each. This embodiment also has four extensions 1030, 1032, 1034 and 1036 so that the plateguard 100 can attach to the car. Both embodiment 9 and 10 each have square tabs to hold the license plate firmly in place as can be seen by looking at FIG. 9 (970 (a), (b), (c) and (d), and FIG. 10 (1070 (a), (b), (c) and (d)).

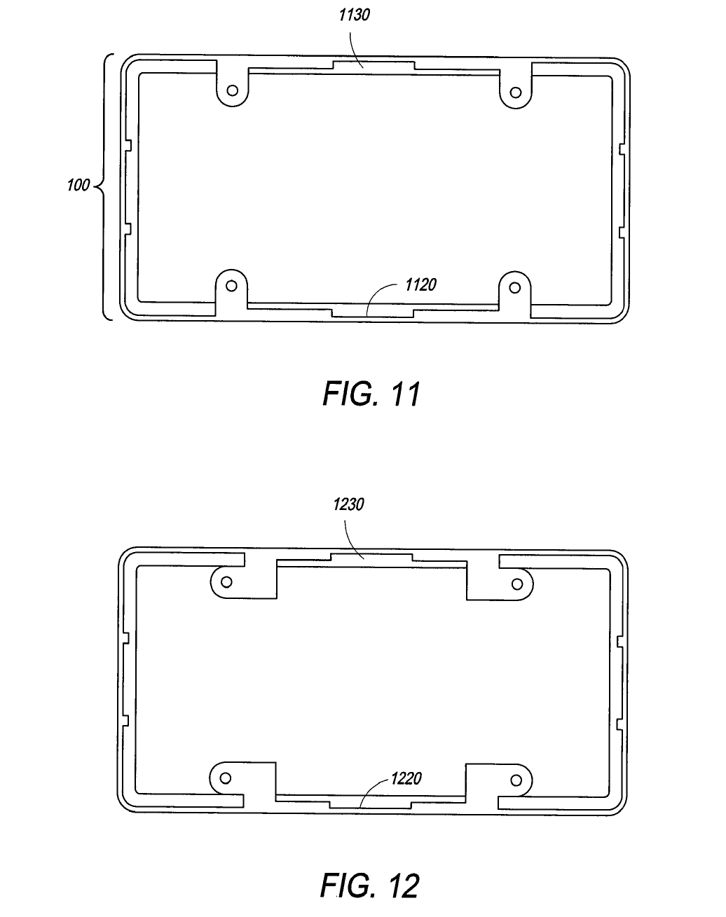

In a few embodiments of the plateguard, the tabs which hold the license plate steady are manufactured with a notch configuration 1130 and 1120 FIG. 11 or 1230 or 1220 FIG. 12 as can be seen in FIGS. 11 and 12. This notch configuration is better suited to certain types of manufacture materials.

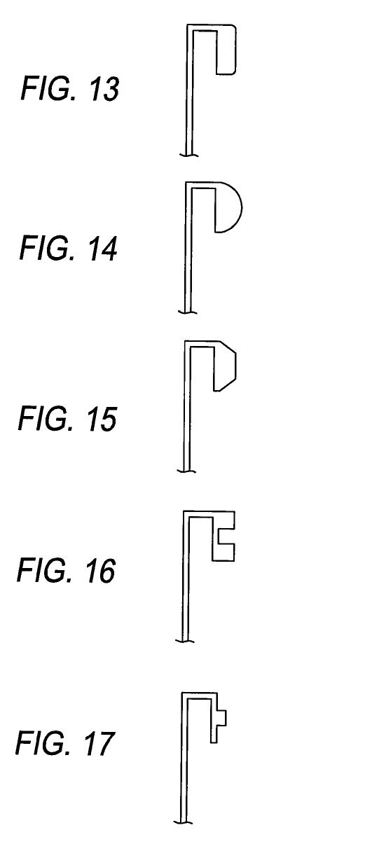

FIGS. 13 through 17 display the exterior dimensions of the plateguard frontal face. Every embodiment of the plateguard can have a different frontal faces. The frontal faces can be manufactured in various configurations such as square, rounded, half circle, diamond, channel or partially raised. These faces are displayed in FIGS. 13 through 17. FIG. 13 shows a square frontal face. This frontal face extends around the circumference of the front side of the plateguard. FIG. 14 displays a rounded frontal face. FIG. 15 displays a half-diamond shaped frontal face. FIG. 16 displays a double column frontal face. FIG. 17 displays a single column frontal face. Each of these frontal face configurations is thick enough to allow the plateguard to be sturdy and not flimsy. The frontal faces of the plateguard can be modified and changed for aesthetic purposes.

The above description of disclosed embodiments is provided to enable any person skilled in the art to make or use the invention. Various modifications to the embodiments will be readily apparent to those skilled in the art, the generic principals defined herein can be applied to other embodiments without departing from spirit or scope of the invention. Thus, the invention is not intended to be limited to the embodiments shown herein but is to be accorded the widest scope consistent with the principals and novel features disclosed herein.

1. A license plate holder which secures a license plate to an automobile including:
a rigid and flexible back portion with at least two screw holes to secure the license plate holder to an automobile or truck,
a rigid and flexible front portion, attached to the back portion, which extends around the circumference of the license plate and covers at a maximum one half inch of the license plate, and
the front and the back portion being manufactured to securely hold a license place with a space between the front portion and back portion into which a license place can be slid and held securely.

2. The license plate holder of claim 1, wherein the front and back portion are one continuous unit.

3. The license plate holder of claim 1, which is manufactured from one or more of the following materials Eastman Durastar™ polymer, high impact polymer, ABS natural plateable grade plastic, ABS plastic, high impact polystyrene (HIPS or PS-I), styrene polymers, styrene, high resistant nylon, heat resistant nylon, sheet metal, aluminum, stainless steel, carbon fiber, flexible graphite, polyurethane, wood, flexible fiberglass, ethylene propylene diene monomer (E.P.D.M.), brass, and dye cast zinc and/or a variety of other substances.

4. The license plate holder of claim 1, wherein the back portion is manufactured in a double diamond shape.

5. The license plate holder of claim 1, including small bendable tabs which surround the back portion and can be bent into the license plate to hold it securely in the license plate holder.

6. The license plate holder of claim 1, wherein the back portion is configured in an H shape wherein the two arms of the H attach to the top and bottom of the license plate holder and the center piece connects the horizontal connector pieces to hold it rigid.

7. The license plate holder of claim 6, wherein the H contains four or more small extensions each with a screw hole passing through it.

8. The license plate holder of claim 1, wherein the license plate is slid into the holder from the top.

9. The license plate holder or claim 1, wherein the license plate is slid into the holder from the right or left side.

10. The license plate holder of claim 1, wherein the front portion has a face which can be configured in multiple shapes which may include various configurations such as square, rounded, half circle, diamond, channel or partially raised.

11. The license plate holder of claim 1, wherein there are no extensions or tabs on the front portion of the license plate holder.

12. A license plate holder to secure a license plate to an automobile or truck including:
a front and a back piece connected together at their edges with a space between the two pieces into which the license plate slides,
the back piece including two or more screw holes to connect the license plate holder to an automobile or truck, and
the front piece including a frame which extends around the front face of the license plate and covers at a minimum ¼ inch of the circumference and at a maximum ½ inch of the circumference.

13. The license plate holder of claim 12, which is manufactured from one or more of the following materials Eastman Durastar™ polymer, high impact polymer, ABS natural plateable grade plastic, ABS plastic, high impact polystyrene (HIPS or PS-I), styrene polymers, styrene, high resistant nylon, heat resistant nylon, sheet metal, aluminum, stainless steel, carbon fiber, flexible graphite, polyurethane, wood, flexible fiberglass, ethylene propylene diene monomer (E.P.D.M.), brass, and dye cast zinc and/or a variety of other substances.

14. The license plate holder of claim 12, wherein the back portion is manufactured in a double diamond shape.

15. The license plate holder of claim 12, including small bendable tabs which surround the back portion and can be bent into the license plate to hold it securely in the license plate holder.

16. The license plate holder of claim 12, wherein the back portion is configured in an H shape wherein the two arms of the H attach to the top and bottom of the license plate holder and the center piece connects the horizontal connector pieces to hold it rigid.

17. The license plate holder of claim 16, wherein the H contains four or more small extensions each with a screw hole passing through it.

18. The license plate holder of claim 12, wherein the license plate is slid into the holder from the top.

19. The license plate holder or claim 12, wherein the license plate is slid into the holder from the right or left side.
